(19) United States
(12) Patent Application Publication
(10) Pub. No.: US 2025/0230927 A1
(43) Pub. Date: Jul. 17, 2025

(54) SYSTEM AND METHOD FOR DECOMISSIONING A STEAM GENERATOR

(71) Applicant: ATS Corporation, Cambridge (CA)

(72) Inventors: David Taro Morikawa, Cambridge (CA); Bernard Argos Majarais, Cambridge (CA); Mark Johannesson, Cambridge (CA)

(21) Appl. No.: 18/705,400

(22) PCT Filed: Oct. 28, 2022
(86) PCT No.: PCT/CA2022/051599

§ 371 Date: Apr. 26, 2024

(51) Int. Cl. F22B 37/00; G21D 1/00

(52) U.S. Cl. CPC F22B 37/007; G21D 1/003

(57) ABSTRACT

A system for decommissioning a steam generator, comprising a structure defining a chamber for receiving the steam generator; and a mechanical assembly within the chamber for dismantling the steam generator.

### CROSS-REFERENCE TO RELATED PATENT APPLICATIONS

This application claims the benefit of U.S. Provisional Patent Application No. 63/272,857, filed on Oct. 28, 2021. The entire contents of U.S. Provisional Patent Application No. 63/272,857 are incorporated herein by reference for all purposes.

### FIELD

The embodiments herein are directed to the field of decommissioning nuclear power plant equipment. More particularly, the embodiments provide systems and methods for decommissioning a steam generator from a nuclear power plant.

### INTRODUCTION

The following is not an admission that anything discussed below is part of the prior art or part of the common general knowledge of a person skilled in the art.

Nuclear power plants contain multiple steam generators connected to the reactor via heat exchange tubes. Each steam generator contains the heat exchange tubes, which are in communication with the reactor, and which carry radioactive fluids between the reactor and the steam generator. At the end of its service life, each steam generator must be decommissioned. Decommissioning a steam generator requires special handling, disposal, and recycling measures of the steam generator and its internal components due to the prolonged exposure to, and contamination by, radioactive material.

Steam generators may be up to 12 feet in diameter and 50-70 feet long. As such, decommissioning a steam generator requires breaking it down into manageably sized pieces to be isolated and cleaned. However, such activity risks direct exposure to the radiation-contaminated components of the steam generator, including magnetite build-up within the heat exchange tubes, and can generate radiation contaminated dust particles risking exposure through inhalation. Exposure to radiation presents numerous health hazards including nausea and vomiting, headache, fever, hair loss, internal bleeding, and cancer, among others. Further, inhalation of radioactive particles may deliver the source of radiation directly to the cells of the body, increasing the risk of developing cancer.

Accordingly, safe decommissioning of steam generators has been sought. For example, in the United Kingdom, the steam generator is place on a barge and shipped to a facility specially equipped to handle radiation contaminated materials. However, given the size and special handling requirements of a steam generator, it is very expensive to decommission a steam generator in this way.

### SUMMARY OF THE SOME EMBODIMENTS

In accordance with one aspect of this disclosure, there is provided a system for decommissioning a steam generator, comprising a structure defining a chamber for receiving the steam generator; and a mechanical assembly within the chamber for dismantling the steam generator.

According to some aspects of some embodiments, the system further comprises at least one support member within the chamber for supporting the steam generator.

According to some aspects of some embodiments, the mechanical assembly comprises at least one mechanical arm assembly within the chamber operable for dismantling the steam generator.

According to some aspects of some embodiments, the at least one mechanical arm assembly comprises at least one dismantling member movable into contact with the steam generator. In one embodiment, the at least one dismantling member may be a circular saw. In one embodiment, the at least one dismantling member may be a reciprocating saw. In one embodiment, the at least one dismantling member may be an oxy acetylene torch. In one embodiment, the at least one dismantling member may be a shear cutter.

According to some aspects of some embodiments, each mechanical arm assembly is operable to dismantle the steam generator into a plurality of segments.

According to some aspects of some embodiments, the mechanical arm assembly further comprises at least one decontaminating member operable to remove contaminants from the steam generator. In one embodiment, the at least one decontaminating member may be a shot blaster. In one embodiment, the at least one decontaminating member may be a decontaminate spray nozzle. In one embodiment, the at least one decontaminating member may be a suction nozzle.

According to some aspects of some embodiments, the mechanical assembly further comprises a gantry frame within the chamber movable along the longitudinal axis of the steam generator for moving the at least one mechanical arm assembly. In one embodiment, the gantry frame comprises at least two vertical frame members for mounting the at least one mechanical arm assembly. In one embodiment, each vertical frame member has a bottom end movable along the ground and a top end opposite the bottom end.

According to some aspects of some embodiments, the mechanical assembly further comprises at least one gantry guide within the chamber for movably mounting the bottom end of at least one of the at least two vertical frame members of the gantry frame and for directing the movement of the gantry frame. In one embodiment, each gantry guide runs adjacent to the steam generator in a direction along the longitudinal axis of the steam generator to direct the movement of the gantry frame. In one embodiment, the gantry guide is a rail. In another embodiment, the gantry guide is a recessed groove.

According to some aspects of some embodiments, the gantry frame further comprises at least one horizontal frame member connected to the top end of each vertical frame member.

According to some aspects of some embodiments, the at least two vertical frame members and the at least one horizontal frame member of the gantry frame define an area for passing the steam generator through as the gantry frame moves along the longitudinal axis of the steam generator.

According to some aspects of some embodiments, the gantry frame further comprises at least one elevator system movable along the longitudinal axis of each vertical frame member for moving the at least one mechanical arm assembly. In one embodiment, each elevator system comprises an elevator platform adjacent to the steam generator for fixedly mounting each mechanical arm assembly.

According to some aspects of some embodiments, the gantry frame further comprises a carrier assembly slidably mounted on the at least one horizontal frame member of the gantry frame. In one embodiment, the carrier assembly is slidable over the steam generator between each vertical frame member.

According to some aspects of some embodiments, the carrier assembly further comprises a segment carrier extendable from the carrier assembly to the steam generator for collecting each of the plurality of segments as the mechanical arm assembly dismantles the steam generator. In one embodiment, the segment carrier is a magnetic lift. In another embodiment, the segment carrier is an operable grasping member.

According to some aspects of some embodiments, the system further comprises a secondary workstation within the chamber for performing a secondary dismantling process on the plurality of segments. In one embodiment, the secondary dismantling process comprises shot blasting the plurality of segments for further removing contaminants. In another embodiment, the secondary dismantling process comprises spraying the plurality of segments with a decontaminating spray for further removing contaminants. In yet another embodiment, the secondary dismantling process comprises cutting the plurality of segments into a plurality of smaller segments for improving storability.

According to some aspects of some embodiments, the system further comprises a storage bin within the chamber for storing a plurality of finished segments from the plurality of segments.

According to some aspects of some embodiments, the gantry frame is movable from a first position around the steam generator to a second position over the secondary workstation and storage bin.

According to some aspects of some embodiments, the system further comprises a debris control curtain within the chamber for separating the chamber into two compartments. In one embodiment, the two compartments comprise a dirty side, wherein dismantling of the steam generator take place, and a clean side opposite the dirty side.

According to some aspects of some embodiments, the system further comprises an air handling unit within the chamber for maintaining a negative air pressure within the dirty side to prevent contaminated air from escaping to the clean side. In one embodiment, the air handling unit further maintains a negative air pressure within the chamber to prevent contaminated air from escaping to the exterior of the structure.

According to some aspects of some embodiments, the system further comprises a plurality of cameras within the chamber for observing the chamber from outside the structure. In one embodiment, the plurality of cameras comprises a plurality of cameras around an upper perimeter of the chamber for providing an aerial view of the mechanical assembly. In another embodiment, the plurality of cameras further comprises a plurality of cameras mounted on the mechanical assembly for providing a point of view of each component of the mechanical assembly.

According to some aspects of some embodiments, the at least one support member comprises an upper support region sized and shaped to engage with an outer metal shell of the steam generator. In one embodiment, each support member further comprises a support body sized to hold the steam generator such that the longitudinal axis of the steam generator is substantially horizontal.

In accordance with one aspect of this disclosure, there is provided a method of decommissioning a steam generator, comprising positioning a steam generator within a chamber defined by a structure; and operating a mechanical assembly within the chamber to perform a dismantling procedure on the steam generator.

According to some aspects of some embodiments, the method further comprises supporting the steam generator within the chamber with at least one support member.

According to some aspects of some embodiments, the mechanical assembly comprises at least one mechanical arm assembly within the chamber, and the method further comprises operating each mechanical arm assembly to perform the dismantling procedure on the steam generator.

According to some aspects of some embodiments, the at least one mechanical arm assembly comprises at least one dismantling member, and the method further comprises moving the dismantling member into contact with the steam generator to remove a segment of the steam generator. In one embodiment, the at least one dismantling member is a circular saw, and the method further comprises operating the circular saw to cut away a segment of the steam generator. In another embodiment, the at least one dismantling member is a reciprocating saw, and the method further comprises operating the reciprocating saw to cut away a segment of the steam generator. In another embodiment, the at least one dismantling member is an oxy acetylene torch, and the method further comprises operating the oxy acetylene torch to cut away a segment of the steam generator. In yet another embodiment, the at least one dismantling member is a shear cutter, and the method further comprises operating the shear cutter to cut away a segment of the steam generator.

According to some aspects of some embodiments, the method further comprises operating the mechanical arm assembly to dismantle the steam generator into a plurality of segments.

According to some aspects of some embodiments, the at least one mechanical arm assembly further comprises at least one decontaminating member, and the method further comprises operating each decontaminating member to remove contaminants from the steam generator. In one embodiment, the at least one decontaminating member is a shot blaster, and the method further comprises operating the shot blaster to remove contaminants from at least one of the plurality of segments. In another embodiment, the at least one decontaminating member is a decontaminate spray nozzle, and the method further comprises operating the decontaminate spray nozzle to remove contaminants from at least one of the plurality of segments. In yet another embodiment, the at least one decontaminating member is a suction nozzle, and the method further comprises operating the suction nozzle to remove contaminants from at least one of the plurality of segments.

According to some aspects of some embodiments, the mechanical assembly further comprises a gantry frame within the chamber, and the method further comprises moving the gantry frame along the longitudinal axis of the steam generator for moving the at least one mechanical arm assembly. In one embodiment, the gantry frame comprises at least two vertical frame members for mounting each mechanical arm assembly, and the method further comprises moving each mechanical arm assembly along the longitudinal axis of each vertical frame member. In another embodiment, each of the vertical frame members has a bottom end movable along the ground and a top end opposite the bottom end, and the method further comprises moving the bottom end along the ground to change the position of each mechanical arm assembly along the longitudinal axis of the steam generator.

According to some aspects of some embodiments, the mechanical assembly further comprises at least one gantry guide within the chamber for movably mounting the bottom end of at least one of the at least two vertical frame members of the gantry frame, and the method further comprises directing the movement of the gantry frame. In one embodiment, each gantry guide runs adjacent to the steam generator in a direction along the longitudinal axis of the steam generator, and the method further comprises directing the movement of the gantry frame along the longitudinal axis of the steam generator.

According to some aspects of some embodiments, the gantry frame further comprises at least one horizontal frame member connected to the top end of each vertical frame member, and the method further comprises positioning the horizontal frame member above the steam generator.

According to some aspects of some embodiments, the method further comprises passing the steam generator through an area defined by the at least two vertical frame members and the at least one horizontal frame member of the gantry frame while moving the gantry frame along the longitudinal axis of the steam generator.

According to some aspects of some embodiments, the gantry frame further comprises at least one elevator system integrated into each vertical frame member, and the method further comprises moving the at least one elevator system along the longitudinal axis of each vertical frame member for moving the at least one mechanical arm assembly. In one embodiment, the elevator system comprises an elevator platform adjacent to the steam generator for fixedly mounting the mechanical arm assembly, and the method further comprises moving the elevator platform to move each mechanical arm assembly along the longitudinal axis of each vertical frame member.

According to some aspects of some embodiments, the gantry frame further comprises a carrier assembly slidably mounted on the at least one horizontal frame member of the gantry frame, and the method further comprises positioning the carrier assembly above a segment to be cut from the steam generator. In one embodiment, the carrier assembly comprises a segment carrier extendable from the carrier assembly, and the method further comprises extending the segment carrier from the carrier assembly to the steam generator for collecting the segment to be cut from the steam generator. In one embodiment, the segment carrier is a magnetic lift, and the method further comprises magnetically holding the segment to be cut from the steam generator. In another embodiment, the segment carrier is an operable grasping member, and the method further comprises grasping the segment to be cut from the steam generator.

According to some aspects of some embodiments, the mechanical assembly further comprises a secondary workstation within the chamber, and the method further comprises performing a secondary dismantling process on the plurality of segments. In one embodiment, the secondary dismantling process comprises shot blasting, and the method further comprises shot blasting the plurality of segments for further removing contaminants. In another embodiment, the secondary dismantling process comprises spraying with decontaminate spray, and the method further comprises spraying the plurality of segments with decontaminate spray for further removing contaminants. In yet another embodiment, the secondary dismantling process comprises cutting, and the method further comprises cutting the plurality of segments into a plurality of smaller segments for improving storability.

According to some aspects of some embodiments, the mechanical assembly further comprises a storage bin within the chamber, and the method further comprises storing a plurality of finished segments from the plurality of segments in the storage bin.

According to some aspects of some embodiments, the method further comprises moving the gantry frame from a first position around the steam generator to a second position over the secondary workstation and storage bin.

According to some aspects of some embodiments, the method further comprises moving a debris control curtain within the chamber for separating the chamber into two compartments. In one embodiment, the method further comprises performing the dismantling procedure on the steam generator on a dirty side of the debris control curtain opposite a clean side.

According to some aspects of some embodiments, the mechanical assembly further comprises an air handling unit within the chamber, and the method further comprises operating the air handling unit for maintaining a negative air pressure within the dirty side to prevent contaminated air from escaping to the clean side. In one embodiment, the method further comprises operating the air handling unit to for maintaining a negative air pressure within the chamber to prevent contaminated air from escaping to the exterior of the structure.

According to some aspects of some embodiments, the method further comprises operating a plurality of cameras within the chamber for observing the chamber from outside the structure. In one embodiment, the plurality of cameras comprises a plurality of cameras mounted around an upper perimeter of the chamber for providing an aerial view of the mechanical assembly, and the method further comprises operating the plurality of cameras to oversee the dismantling procedures. In another embodiment, the plurality of cameras further comprises a plurality of cameras mounted on the mechanical assembly, and the method further comprises operating the plurality of cameras to view from each component of the mechanical assembly.

According to some aspects of some embodiments, the at least one support member comprises an upper support region sized and shaped to engage with an outer metal shell of the steam generator, and the method further comprises mounting the steam generator on the upper support region of each support member.

According to some aspects of some embodiments, the method further comprises moving the gantry frame back to the first position around the steam generator from the second position over the secondary workstation and storage bin, wherein the first position is variable along the longitudinal axis of the steam generator dependent on the location of the next segment to be cut.

According to some aspects of some embodiments, the method further comprises programming the mechanical assembly to sequentially follow the dismantling procedure.

According to some aspects of some embodiments, the method further comprises an operator located external to the structure operating the mechanical assembly via the plurality of cameras to follow the dismantling procedure.

These and other aspect and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 shows a front perspective view of an example embodiment of a system for decommissioning a steam generator;

FIG. 2 shows a front perspective view of an example embodiment of the system for decommissioning a steam generator of FIG. 1, without the walls of the structure shown;

FIG. 3 shows a top view of the system for decommissioning a steam generator of FIG. 2;

FIG. 4 shows a front elevation view of the system for decommissioning a steam generator of FIG. 2;

FIG. 5 shows a side elevation view of the system for decommissioning a steam generator of FIG. 2;

FIG. 6 shows a zoomed in front perspective view of the system for decommissioning a steam generator of FIG. 2, with the upper portion of the steam generator having been removed during disassembly procedures;

FIG. 7 shows a zoomed in front perspective view of the system for decommissioning a steam generator of FIG. 6, with the end cap of the lower portion of the steam generator having been removed during disassembly procedures;

FIG. 8 shows a side cross-sectional view of the system for decommissioning a steam generator of FIG. 7; and

FIG. 9 shows a rear perspective view of the container of FIG. 7, with the top half of the outer housing of the lower portion of the steam generator having been removed during disassembly procedures.

The drawings included herewith are for illustrating various examples of articles, methods, and apparatuses of the teachings of the preset specification and are not intended to limit the scope of what is taught in any way.

### DESCRIPTION OF EXAMPLE EMBODIMENTS

Various apparatuses will be described below to provide an example of one or more embodiments. No embodiment described below limits any claims and any claims may cover apparatuses that differ from those described below. The claims are not limited to apparatuses, methods or systems having all of the features of any one apparatus, method, or system described below or to features common to multiple or all of the apparatuses, methods and systems described below.

It is possible that an apparatus, system or method described herein is not an embodiment of any claim. Any embodiment disclosed herein that is not claimed in this document may be the subject matter of another protective instrument, for example, a continuing patent application, and the applicants, inventors or owners do not intend to abandon, disclaim or dedicate to the public any such embodiment merely by its disclosure in this document.

The terms “including”, “comprising”, and variations thereof mean “including but not limited to”, unless expressly specified otherwise. A listing of items does not imply that any or all of the items are mutually exclusive, unless expressly specified otherwise. The terms “a”, “an”, and “the” mean “one or more”, unless expressly specified otherwise.

As used herein and in the claims, two or more parts are said to be “coupled”, “connected”, “attached”, “mounted” or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. As used herein, two or more parts are said to be “rigidly coupled”, “rigidly connected”, “rigidly attached”, or “rigidly fastened” where the parts are coupled so as to move as one while maintaining a constant orientation relative to each other. None of the terms “coupled”, “connected”, “attached”, “mounted”, and “fastened” distinguish the manner in which two or more parts are joined together.

Some elements herein may be identified by a part number, which is composed of a base number followed by an alphabetical or subscript-numerical suffix (e.g., 112a, or 1121). Multiple elements herein may be identified by part numbers that share a base number in common and that differ by their suffixes (e.g., 1121, 1122, and 1123). Elements with a common base number may in some cases be referred to collectively or generically using the base number without a suffix (e.g., 112).

It should be noted that terms of degree such as “substantially”, “about”, and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

It should also be noted that, as used herein, the wording “and/or” is intended to represent an inclusive-or. That is, “X and/or Y” is intended to mean X or Y or both X and Y, for example. As a further example, “X, Y, and/or Z” is intended to mean X or Y or Z or any combination thereof of X, Y, and Z.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

### General Description

In some examples, similar references may be used in different figures to denote similar components. Decommissioning a steam generator requires a means to safely dismantle the steam generator being decommissioned into a many small, manageable segments to be recycled or disposed. Current means required prolonged, direct contact with the steam generator and the radioactive contaminants thereon. Dismantling procedures also generate dust particles contaminated with radiation, creating increased health risks through inhalation of the radioactive particles. Alternatively, these health risks have been mitigated at significant expense by transporting the steam generators great distances to facilities specially equipped to decommission components of a nuclear power plant. Accordingly, decommissioning a steam generator comes with significant health and/or financial implications.

Disclosed herein are example embodiments and methods of a system for decommissioning a steam generator that may make decommissioning steam generators a safe and/or cost-effective process. In accordance with one or more aspects described herein, the system may include a structure that may be erected on-location at a nuclear power plant or at a nearby secure location. The structure may be, for example, a tent, a quonset hut, a shipping container, or a conventionally constructed building. Accordingly, the structure may be constructed from any suitable material for forming a closed environment including, but not limited to, fabric (e.g., polyester, nylon, or polyvinyl chloride laminated), fiberglass, or metal (e.g., aluminum, steel, or titanium). Further, the structure may be temporary, permanent, or semi-permanent. For example, the structure may be set up temporarily to decommission a single defective steam generator, semi-permanently to decommission a plurality of steam generators at the end of their service life, or permanently for use on an as-needed basis. Accordingly, the structure may be erected at any secured location and for any duration, depending on the needs of the user. Further, the structure may be constructed to accommodate various uses. For example, the structure may be a fixed construction, mobile, or transportable, which may depend on whether the intended use is temporary, permanent, or semi-permanent.

### System

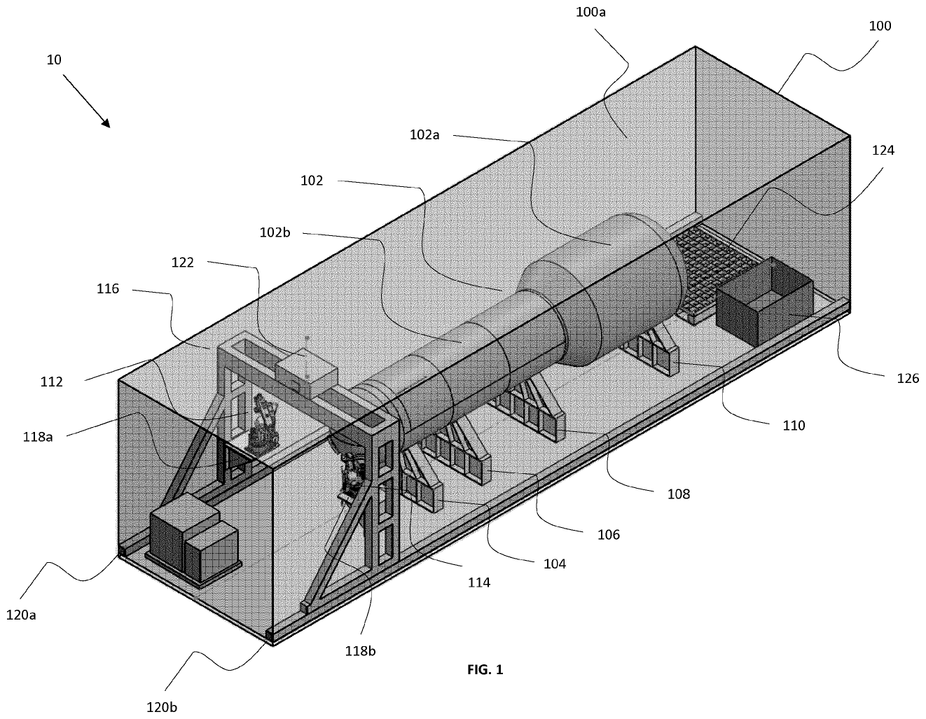

Referring to FIG. 1, shown therein is a system 10 for decommissioning a steam generator 102, wherein the steam generator 102 is located within a chamber 100a defined by a structure 100. The structure may be of any shape and size suitable for housing a steam generator. For example, as shown in FIG. 1, the structure 100 may be substantially rectangular. In this example embodiment, the chamber 100a may also be substantially rectangular as defined by the bounds of the structure. A rectangular structure may make the system more suitable for mobile or transportable construction, such as on the chassis of a tractor trailer, for example.

Further, as shown in FIG. 1, the structure 100 may be greater in length, width, and height than the steam generator 102. A conventional steam generator may have an outer shell wherein the diameter of the outer shell varies across the longitudinal axis of the steam generator. Accordingly, the structure may be sized to accommodate the largest diameter of the steam generator. For example, as shown in FIG. 1, the steam generator 102 comprises an upper portion 102a and a lower portion 102b, wherein the upper portion has a diameter greater than that of the lower portion, and the structure 100 is sized such that the width and height of the chamber 100a exceeds the outer diameter of the upper portion 102a of the steam generator 102.

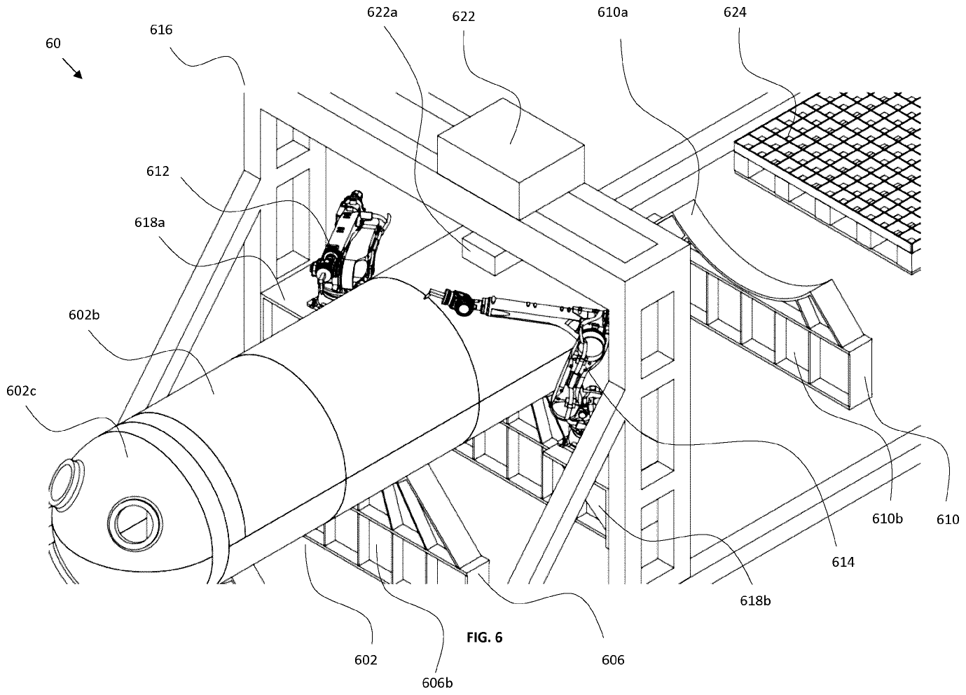

Within the chamber, the steam generator may be mounted on support members to hold the steam generator in a fixed position. The support members may be of any number suitable for holding the steam generator while dismantling procedures take place. For example, as shown in FIG. 1, there may be four support members 104, 106, 108, 110 shaped and sized for supporting the steam generator in a stationary and substantially horizontal position. The support members may be any shape and size suitable for holding the steam generator stationary and at a desired angle while dismantling procedures take place. For example, as shown in FIG. 6, support member 610 for supporting the upper portion 602a of the steam generator 602 may have a support member body 610b shorter than that of the support members supporting the lower portion, such as support member body 606b. Sizing the support members according to the diameter of the steam generator may enable the steam generator to be held at a substantially horizontal orientation. Further, the support members may have an upper support region with a shape and size to engage the outer metal shell of the steam generator. For example, referring again to FIG. 6, support member 610 is shown with upper support region 610a with a shape and size suitable for engaging the cylindrical outer metal shell of the upper portion (not shown) of steam generator 602.

Returning to FIG. 1, the system 10 as shown may further comprise a mechanical assembly housed within the chamber for dismantling the steam generator. A mechanical assembly may provide the advantage of minimizing the need for, and duration of, human exposure to the steam generator and the radiation contaminated components thereof. Accordingly, a mechanical assembly my include components for cutting or dismantling the steam generator into a plurality of smaller segments, cleaning or decontaminating the steam generator and/or segments, and transporting and storing the segments, among other possible components. For example, as shown in FIG. 1, the mechanical assembly may include mechanical arm assemblies 112, 114 for dismantling the steam generator 102 into a plurality of segments; a gantry frame 116 for moving the mechanical arm assemblies 112, 114 along the longitudinal axis of the steam generator 102 as the mechanical arm assemblies 112, 114 sequentially dismantle the steam generator 102 into a plurality of segments; elevator platforms 118a, 118b for moving the mechanical arm assemblies 112, 114 in the vertical direction adjacent to the steam generator 102; gantry guides 120a, 120b on the floor of the chamber 100a for directing the motion of the gantry frame 116 along the longitudinal axis of the steam generator 102; a carrier assembly 122 slidable along the top of the gantry frame 116 for holding the segments as they are cut and transported away from the steam generator 102; and a secondary workstation 124 and/or storage bin 126 at which the plurality of segments may be deposited by the carrier assembly 122 for a secondary dismantling process and/or storage of the finished segments.

Accordingly, the width and height of the structure may further be sized to accommodate the mechanical assembly. For example, as shown in FIG. 1, the structure 100 defines a chamber 100a with a width greater than the width of the gantry frame 116 and a height greater than the height of the support members 104, 106, 108, 110, plus the gantry frame 116, plus the height of the carrier assembly 122. Further, as shown in FIG. 1, the structure 100 defines a chamber 100a with a length greater than the length of the steam generator 102, plus the gantry frame 116, plus the secondary workstation 124 and/or storage bin 126. However, any length, width and height may be possible to accommodate any other possible configuration of the mechanical assembly.

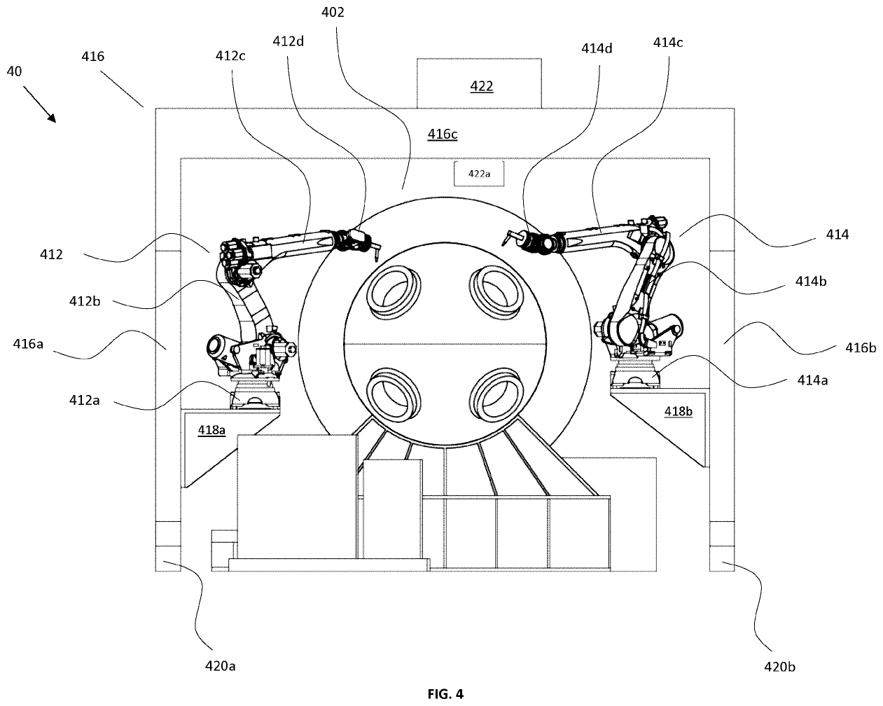

Referring now to FIG. 4, shown therein is a front elevation view of an example embodiment of a system 40 for decommissioning a steam generator. To effectively replace a human worker in dismantling a steam generator, a mechanical assembly may be flexible enough to move such that it all locations of the steam generator may fall within the range of motion of the mechanical assembly.

For example, as shown in FIG. 4, the mechanical assembly may comprise two mechanical arm assemblies 412, 414 disposed on either side of the steam generator 402. The mechanical arm assemblies 412, 414 may be mounted on elevator platforms 418a, 418b by their bases 412a, 414a. The bases 412a, 414a may be fixedly mounted or rotatably mounted to the elevator platforms 418a, 418b such that the mechanical arm assemblies 412, 414 are rotatable about an axis substantially perpendicular to the surface of the elevator platforms 418a, 418b. The mechanical arm assemblies 412, 414 may further comprise lower arm members 412b, 414b coupled to the bases 412a, 414a, and which may alternatively be rotatable about the axis substantially perpendicular to the surface of the elevator platforms 418a, 418b. The lower arm members 412b, 414b may additionally or alternatively be pivotably coupled to the bases 412a, 414b such that they are pivotable about a substantially horizontal axis. The mechanical arm assemblies may further comprise upper arm members 412c, 414c coupled to the lower arm members 412b, 414b, and which may additionally or alternatively be rotatable about the longitudinal axis of the lower arm members 412b, 414b. The upper arm members 412c, 414c may additionally or alternatively be pivotably coupled to the lower arm members 412b, 414b such that they are pivotable about an axis substantially perpendicular to the longitudinal axis of the lower arm members 412b, 414b. The mechanical arm assemblies 412, 414 may further comprise dismantling members 412d, 414d which may be similarly rotatably and/or pivotably coupled to the upper arm members 412c, 414c.

Mechanical arm assemblies of the type described herein may have the range of motion necessary to reach across or substantially across the diameter of the steam generator such that the steam generator may be dismantled entirely by the mechanical arm assemblies. In the example embodiment of FIG. 4, two mechanical arm assemblies are used. However, any number of mechanical arm assemblies may be used. For example, one mechanical arm assembly with sufficient range of motion to reach across or substantially across the diameter of the steam generator may be used.

In some embodiments, the dismantling member of the mechanical arm assemblies may be one of a circular saw, a reciprocating saw, an oxy acetylene torch, or shear cutters. For example, as shown in FIG. 4, the dismantling members 412d, 414d are each an oxy acetylene torch. However, the dismantling member of the mechanical arm assemblies may be any mechanism suitable for cutting a steam generator into a plurality of segments.

In some embodiments, the mechanical arm assemblies may further comprise a decontaminating member operable to remove contaminants from the steam generator. For example, the decontaminating member may be a shot blaster, a decontaminate spray nozzle, or a suction nozzle. However, the decontaminating member of the mechanical arm assemblies may be any mechanism suitable for removing and/or neutralizing radioactive contaminants on the steam generator and the components thereof.

Referring still to FIG. 4, shown therein is a gantry frame 416 comprising two vertical frame members 416a, 416b and a horizontal frame member 416c. A gantry frame may be suitable for supporting a plurality of components of the mechanical assembly. For example, as shown in FIG. 4, the gantry frame 416 comprises the elevator platforms 418a, 418b integrated into the vertical frame members 416a, 416b, respectively, which further carry the mechanical arm assemblies 412, 414, respectively, in the vertical direction adjacent the steam generator 402. In this embodiment, the gantry frame 416 further comprises a carrier assembly 422, including a segment carrier 422a, slidably mounted on the horizontal frame member 416c above the steam generator 402.

Any other configuration of the gantry frame is possible. For example, there may be one mechanical arm assembly, a plurality of mechanical arm assemblies on each vertical frame member, a segment carrier on a vertical frame member, a mechanical arm assembly on the horizontal frame member, or a plurality of gantry frames with designated functions (e.g., one for cutting, one for carrying).

Referring still to FIG. 4, the gantry frame 416 may be movably mounted on gantry guides 420a, 420b, which may direct the movement of the gantry frame, and the components of the mechanical assembly mounted thereon, along the longitudinal axis of the steam generator 402. The gantry guides may be any configuration suitable for fixing the direction of motion of the gantry frame. For example, as shown in FIG. 4, the gantry guides 420a, 420b may be a rail. Alternatively, the gantry guides may be a recessed groove.

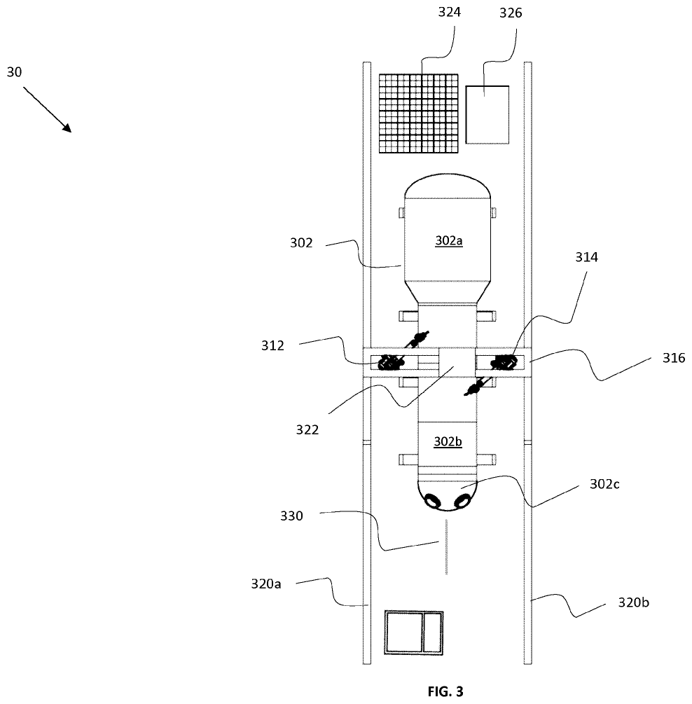

Referring now to FIG. 3, shown therein is a top view of an example embodiment of a system 30. In the example embodiment shown, the gantry guides 320a, 320b may direct the gantry frame 316 along the longitudinal axis 330 of the steam generator 302. The gantry guides 320a, 320b may therefore enable the gantry frame 316 to move to any position along the longitudinal axis 330 of the steam generator 302. For example, as shown in FIG. 3, the gantry frame 316 may be positioned around the lower portion 302b. The gantry frame 316 may also be positioned over the upper portion 302a, at the lower portion end cap 302c, or over the secondary workstation 324 and/or storage bin 326, and any position therebetween. This may enable the mechanical arm assemblies 312, 314, which may be mounted on the gantry frame, to access any portion of the steam generator 302 for dismantling the steam generator into a plurality of segments.

Referring again to FIG. 4, the embodiment shown therein includes the elevator platforms 418a, 418b moveably integrated into the vertical frame members 416a, 416b, respectively, of the gantry frame 416, and which may be used for mounting the mechanical arm assemblies 412, 414, respectively. The elevator platforms 418a, 418b may be movable in the vertical direction such that mechanical arm assemblies 412, 414 may be positioned adjacent to the steam generator 402 anywhere along the vertical axis of the steam generator.

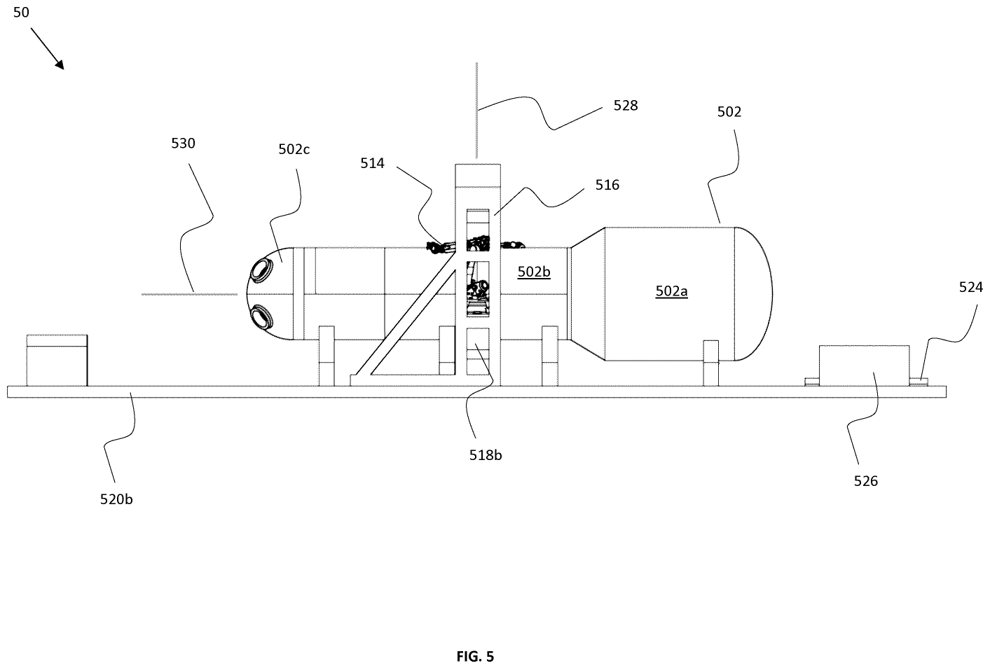

Turning briefly to FIG. 5, shown therein are representations of the longitudinal axis 530 and vertical axis 528 of steam generator 502, which may be used as references for the longitudinal axis and vertical axis of each embodiment of the steam generator disclosed herein.

Referring once more to FIG. 4, shown therein is a carrier assembly 422 slidably mounted on top of the horizontal frame member 416c of the gantry frame 416, the carrier assembly 422 comprising a segment carrier 422a located beneath horizontal frame member 416c. The segment carrier 422a may be extendable from the carrier assembly 422 to the steam generator 402. The segment carrier 422a may securely hold each of the plurality of segments cut from the steam generator while it is cut. It may then carry the segment during the movement of the gantry frame 416 to a new location away from steam generator 402.

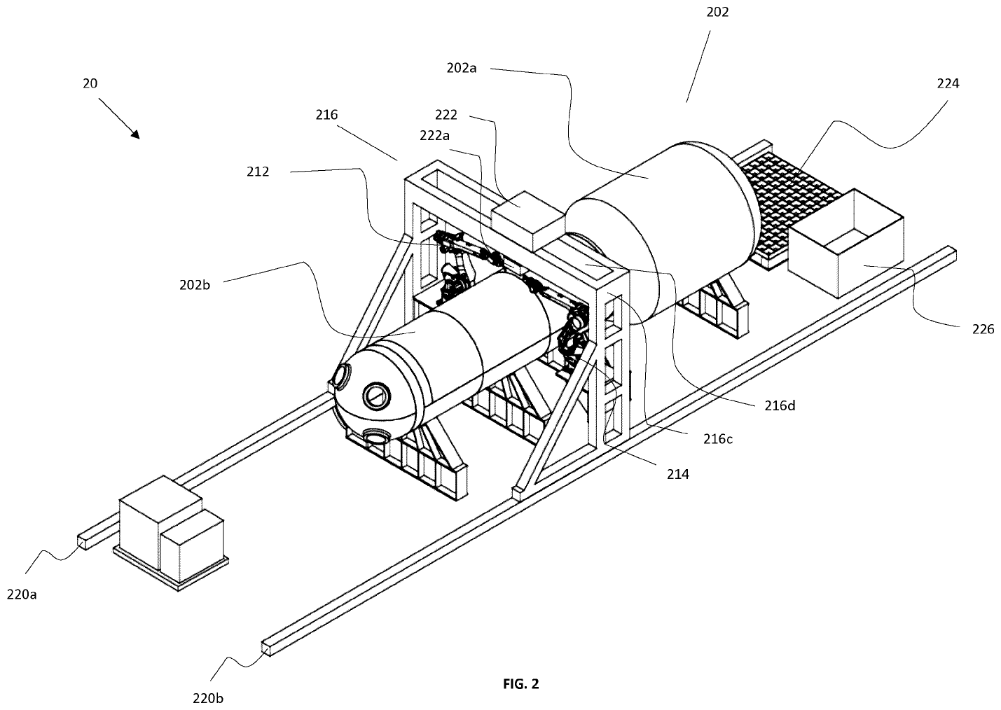

The horizontal frame member of the gantry frame may be configured to facilitate sliding the carrier assembly along the top of the horizontal frame member while also permitting the segment carrier to extend from the segment carrier to the underside of the horizontal frame member. For example, referring to FIG. 2, shown therein is another example embodiment of system 20 comprising a gantry frame 216 with a horizontal frame member 216c. The horizontal frame member may have a slot 216d for slidably engaging the carrier assembly 222 and permitting the segment carrier 222a to extend through the horizontal frame member 216c to the steam generator 202. In the embodiment shown, the carrier assembly 222 may be positioned above the segment to be cut by the mechanical arm assemblies 212, 214, and the segment carrier 222a may extend to hold the segment to be cut. Once separated from the steam generator 202, the segment may be lifted away from the steam generator by the segment carrier 222a, and the gantry frame 216 may move along the gantry guides 220a, 220b to a position over the secondary workstation 224 and/or the storage bin 226. At this location, the carrier assembly 222 may position the segment carrier 222a over the secondary workstation 224 or the storage bin 226 for a secondary dismantling process and/or storage for disposal or recycling.

The segment carrier may be any mechanism suitable for holding, carrying, and releasing a segment of a steam generator. In some embodiments, the segment carrier may be a magnetic lift. In some embodiments, the segment carrier may be an operable grasping member.

It may be necessary to further clean or dismantle the segments removed from the steam generator. Such secondary dismantling processes may take place at a secondary workstation within the chamber. For example, in one embodiment, the secondary dismantling process at the secondary workstation may comprise shot blasting and/or spraying with a decontaminate spray to further remove any radioactive contaminants from the segment. Additionally, or in the alternative, in one embodiment the secondary dismantling process may comprise further cutting the segment into a plurality of smaller segments for improved storability. In some embodiments, the secondary dismantling process may be performed by the mechanical arm assemblies. In some embodiments, the secondary dismantling process may be performed mechanically by a second mechanical assembly. In some embodiments, the secondary dismantling process may be performed by a human worker.

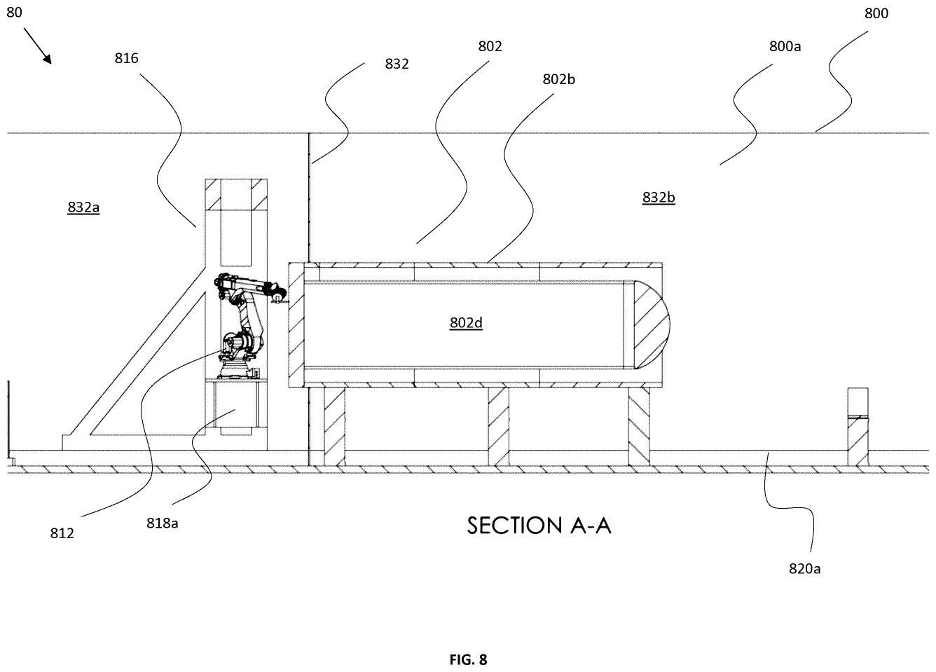

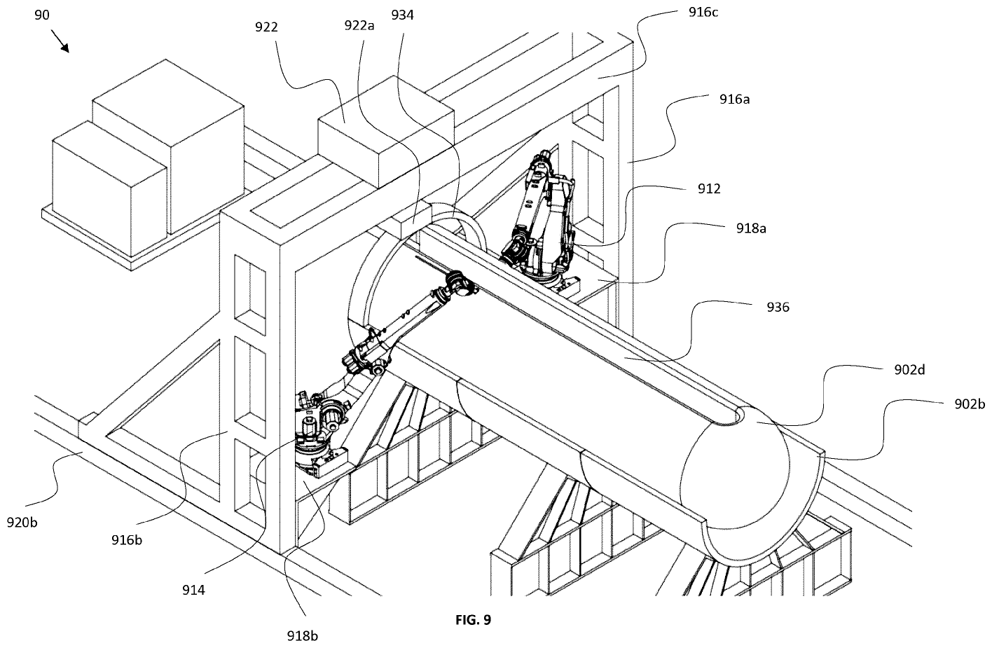

In some embodiments, the system may further comprise a debris control curtain for separating the chamber into two compartments. For example, as shown in FIG. 8, the debris control curtain 832 may separate the chamber into a clean side 832b and a dirty side 832a, wherein dismantling procedures which may generate radiation contaminated dust particles take place on the dirty side 832a. In some embodiments, the secondary workstation may be located on the clean side such as where human workers are performing secondary processing. For example, this configuration is depicted in FIG. 9. In some embodiments, the debris control curtain may be movable with the gantry frame. In some embodiments, the debris control curtain may be movable independently from the gantry frame.

In some embodiments, the system may further comprise an air handling unit. In some embodiments, the air handling unit may maintain a negative air pressure within the dirty side of the chamber to prevent radiation contaminated dust particles from entering the clean side of the chamber. In some embodiments, the air handling unit may additionally or alternatively maintain a negative air pressure within the chamber to prevent radiation contaminated dust particles from escaping to the exterior of the structure.

In some embodiments, the system further comprises a plurality of cameras within the chamber. In some embodiments, the plurality of cameras may be around the upper perimeter of the chamber to provide an aerial view of the mechanical assembly and steam generator therein. In some embodiments, the plurality of cameras may additionally or alternatively comprise a plurality of cameras mounted on the components of the mechanical assembly. For example, cameras may be mounted on the gantry frame, the elevator platforms, the mechanical arm assemblies, and/or the carrier assembly such that a viewer or operator may gain a view from the perspective of the components.

### Method

Referring to FIGS. 5 to 9, shown therein are a sequence of figures depicting an example method for dismantling a steam generator. Referring to FIG. 5, shown therein is an example system 50 comprising a steam generator 502 with an upper portion 502a, a lower portion 502b, and a lower portion end cap 502c. Further shown is a gantry frame 516 mounted on the gantry guides 520b (520a not shown), movable along the longitudinal axis 530 of the steam generator 502 between a first position along the steam generator and a second position over the secondary workstation 524 and/or the storage bin 526. Also shown is the elevator platform 518b with the mechanical arm assembly 514 mounted thereon and movable along the vertical axis 528 of the steam generator 502.

First, the upper portion 502a of the steam generator 502 may be dismantled into a plurality of segments. For example, as shown in FIG. 6, system 60 depicts the steam generator 602 with the upper portion removed. This may be completed by moving the gantry frame 616 to a first position around the upper portion; positioning the carrier assembly 622 over a segment to be cut; extending the segment carrier 622a to hold the segment to be cut; positioning the elevator assemblies 618a, 618b at a vertical position such that the segment to be cut is within the range of motion of the mechanical arm assemblies 612, 614; operating the mechanical arm assemblies 612, 614 to cut the segment; retracting the segment carrier 622a from the upper portion with the segment; moving the gantry frame to a second position over the secondary workstation 624 and/or storage bin (not shown); depositing the segment at the second position; and returning to the first position, wherein the first position may vary depending on the location of the next segment to be cut. This sequence my be repeated until the upper portion of the steam generator has been completely dismantled as shown in FIG. 6.

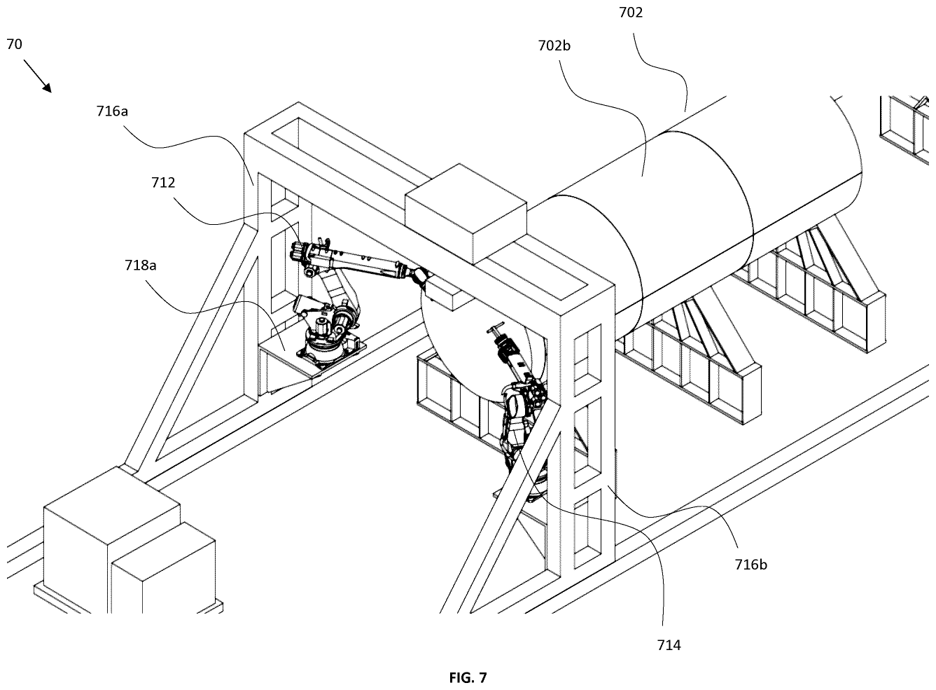

Next, lower portion end cap 602c may be removed. For example, as shown in FIG. 7, system 70 depicts a steam generator 702 with the lower portion end cap removed. In use, the lower portion end cap, sometimes referred to as the bowl, comprises inlets and outlets for the radioactive fluid. Consequentially, the lower portion end cap may be a concentration point of radiation. Accordingly, the method for dismantling the lower portion end cap may be the same as dismantling the upper portion as described above. However, the method may further include operating a decontaminating member to remove radioactive contaminants from the lower portion end cap before dismantling into a plurality of segments, and further removing contaminants during the secondary dismantling process at the secondary workstation.

Referring again to FIG. 7, after the lower portion end cap is dismantled into a plurality of segments, the interior of lower portion 702b may be cleaned by positioning the gantry frame 716 in front of the lower portion 702b, moving the elevator platforms 718a, 718b to the bottom end of the vertical frame members 716a, 716b, and operating the mechanical arm assemblies 712, 714 to perform decontaminating procedures on the interior of lower portion 702b and the internal components thereof. Similar to the lower portion end cap, the interior components (e.g., heat exchange tubes) are directly exposed to the radioactive fluid and therefore may house a higher concentration of radioactive contaminants, requiring additional decontaminating procedures before and after being dismantled into a plurality of segments.

Referring to FIG. 8, shown therein is a cross-sectional view of the system of FIG. 7. Shown therein is system 80 comprising the lower portion 802b of the steam generator 802, including the interior components 802d of the lower portion 802b. Further shown is a debris control curtain 832 separating the chamber 800a of structure 800 into two compartments. In the embodiment shown, the dirty side 832a of the chamber is the side with the gantry frame 816, wherein the mechanical arm assembly 812 is shown performing decontaminating procedures on the interior components 802d, which may generate radiation contaminated dust particles.

Next, the lower portion 802b and the interior components 802d may be dismantled into a plurality of segments. For example, as shown in FIG. 9, the top half of the outer metal shell of the lower portion 902b may be removed. FIG. 9 shows the carrier assembly 922 positioned along the horizontal frame member 916c, with the segment carrier 922a holding a remaining segment of the top half of the outer metal shell of the lower portion 902b yet to be removed. Further shown is the internal component 902d, depicted as a cylindrical tube within the lower portion 902b, with a segment 936 extending along the longitudinal axis of the internal component 902d having been removed. The sequence that may be follow may be the same as that described above with respect to the upper portion of the steam generator in FIG. 6. The sequence my further be broken into stages. For example, as indicated by FIG. 9, the lower portion may be dismantled by first dismantling the top half of the lower portion 902b, then the internal components 902d, and finally the bottom half of the lower portion 902b. Other sequences suitable for dismantling the steam generator while maintaining its position stably mounted on the support members may be followed.

In the method exemplified in FIGS. 5 to 9, a steam generator may be dismantled starting with the upper portion, then the lower portion end cap, and finishing with the lower portion and interior components of the lower portion. Further, the upper portion and lower portion of the steam generator may be dismantled sequentially moving from the top half to the interior components, then to the bottom half. The full sequence as exemplified by FIGS. 5 to 9 may comprise dismantling the top half of the upper portion; then the interior components of the upper portion; then the bottom half of the upper portion; then the lower portion end cap; then the top half of the lower portion; then the interior components of the lower portion; and finally, the bottom half of the lower portion. However, it may be understood that other orders of operation and sequences may be possible.

The mechanical assemblies disclosed herein may be autonomous or user operated. For example, the mechanical assembly may be programmable to automatically follow a dismantling sequence such as the method described above. In some embodiments, the programming may take place within or from outside the chamber. In some embodiments, the mechanical assembly may be pre-programmed with one or more dismantling sequences. Alternatively, in some embodiments, the mechanical assembly may be user operated by a human operator at a location external to the structure. In some embodiments, communication with the mechanical assembly within the chamber may be wireless. In some embodiments, communication with the mechanical assembly within the chamber may be with wired connections.

In some embodiments, the dismantling procedure, whether autonomously conducted or conducted by user operation, may be viewed by a plurality of cameras located around the upper perimeter of the chamber and/or a plurality of cameras mounted on the components of the mechanical assembly as described herein.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples but should be given the broadest interpretation consistent with the description as a whole.

1. A system for decommissioning a steam generator, comprising:
a structure defining a chamber for receiving the steam generator; and
a mechanical assembly within the chamber for dismantling the steam generator.

2. The system of claim 1, further comprising at least one support member within the chamber for supporting the steam generator.

3. The system of claim 2, wherein the mechanical assembly comprises: at least one mechanical arm assembly within the chamber operable for dismantling the steam generator.

4. The system of claim 3, wherein each mechanical arm assembly comprises at least one dismantling member movable into contact with the steam generator to remove a segment of the steam generator.

5. The system of claim 4, wherein the at least one dismantling member is a circular saw.

6. The system of claim 4, wherein the at least one dismantling member is a reciprocating saw.

7. The system of claim 4, wherein the at least one dismantling member is an oxy acetylene torch.

8. The system of claim 4, wherein the at least one dismantling member is a shear cutter.

9. The system of claim 4, wherein the mechanical arm assembly is operable to dismantle the steam generator into a plurality of segments.

10. The system of claim 9, wherein the at least one mechanical arm assembly further comprises at least one decontaminating member operable to remove contaminants from the steam generator.

11. The system of claim 10, wherein the at least one decontaminating member is a shot blaster.

12. The system of claim 10, wherein the at least one decontaminating member is a decontaminate spray nozzle.

13. The system of claim 10, wherein the at least one decontaminating member is a suction nozzle.

14. The system of claim 10, wherein the mechanical assembly further comprises a gantry frame within the chamber movable along the longitudinal axis of the steam generator for moving each mechanical arm assembly.

15. The system of claim 14, wherein the gantry frame comprises at least two vertical frame members for mounting each mechanical arm assembly.

16. The system of claim 15, wherein each vertical frame member has a bottom end movable along the ground and a top end opposite the bottom end.

17. The system of claim 16, wherein the mechanical assembly further comprises at least one gantry guide within the chamber for movably mounting the bottom end of at least one of the at least two vertical frame members of the gantry frame and for directing the movement of the gantry frame.

18. The system of claim 17, wherein each gantry guide runs adjacent to the steam generator in a direction along the longitudinal axis of the steam generator to direct the movement of the gantry frame.

19. The system of claim 18, wherein the at least one gantry guide is a rail.

20. The system of claim 18, wherein the at least one gantry guide is a recessed groove.

21. The system of claim 18, wherein the gantry frame further comprises at least one horizontal frame member connected to the top end of each of the at least two vertical frame members.

22. The system of claim 21, wherein the at least two vertical frame members and the at least one horizontal frame member of the gantry frame define an area for passing the steam generator through as the gantry frame moves along the longitudinal axis of the steam generator.

23. The system of claim 22, wherein the gantry frame further comprises at least one elevator system moveable along the longitudinal axis of each vertical frame member for moving the at least one mechanical arm assembly.

24. The system of claim 23, wherein the at least one elevator system comprises an elevator platform adjacent to the steam generator for mounting each mechanical arm assembly.

25. The system of claim 24, wherein the gantry frame further comprises a carrier assembly slidably mounted on the at least one horizontal frame member of the gantry frame.

26. The system of claim 25, wherein the carrier assembly is slidable over the steam generator between each vertical frame member.

27. The system of claim 26, wherein the carrier assembly further comprises a segment carrier extendable from the carrier assembly to the steam generator for collecting each of the plurality of segments as the mechanical arm assembly dismantles the steam generator.

28. The system of claim 27, wherein the segment carrier is a magnetic lift.

29. The system of claim 27, wherein the segment carrier is an operable grasping member.

30. The system of claim 27, further comprising a secondary workstation within the chamber for performing a secondary dismantling process to be performed on at least one of the plurality of segments.

31. The system of claim 30, wherein the secondary dismantling process comprises shot blasting the plurality of segments for further removing contaminants.

32. The system of claim 30, wherein the secondary dismantling process comprises spraying the plurality of segments with a decontaminating spray for further removing contaminants.

33. The system of claim 30, wherein the secondary dismantling process comprises cutting the plurality of segments into a plurality of smaller segments for improving storability.

34. The system of claim 30, further comprising a storage bin within the chamber for storing a plurality of finished segments from the plurality of segments.

35. The system of claim 34, wherein the gantry frame is movable from a first position around the steam generator to a second position over the secondary workstation and storage bin.

36. The system of claim 35, further comprising a debris control curtain within the chamber for separating the chamber into two compartments.

37. The system of claim 36, wherein the two compartments comprise a dirty side, wherein dismantling of the steam generator takes place, and a clean side opposite the dirty side.

38. The system of claim 37, further comprising an air handling unit within the chamber for maintaining a negative air pressure within the dirty side to prevent contaminated air from escaping to the clean side.

39. The system of claim 38, wherein the air handling unit further maintains a negative air pressure within the chamber to prevent contaminated air from escaping to the exterior of the structure.

40. The system of claim 39, further comprising a plurality of cameras within the chamber for observing the chamber from outside the structure.

41. The system of claim 40, wherein the plurality of cameras comprises a plurality of cameras mounted around an upper perimeter of the chamber for providing an aerial view of the chamber.

42. The system of claim 41, wherein the plurality of cameras further comprises a plurality of cameras mounted on the mechanical assembly for providing a point of view of each component of the mechanical assembly.

43. The system of claim 42, wherein the at least one support member comprises an upper support region sized and shaped to engage with an outer metal shell of the steam generator.

44. The system of claim 43, wherein each support member further comprises a support body sized to hold the steam generator such that the longitudinal axis of the steam generator is substantially horizontal.

45. A method of decommissioning a steam generator, comprising:
positioning a steam generator within a chamber defined by a structure; and
operating a mechanical assembly within the chamber to perform a dismantling procedure on the steam generator.

46. The method of claim 45, further comprising supporting the steam generator within the chamber with at least one support member.

47. The method of claim 46, wherein the mechanical assembly comprises at least one mechanical arm assembly within the chamber, and the method further comprises: operating each mechanical arm assembly to perform the dismantling procedure on the steam generator.

48. The method of claim 47, wherein each mechanical arm assembly comprises at least one dismantling member, and the method further comprises: moving the dismantling member into contact with the steam generator to remove a segment of the steam generator.

49. The method of claim 48, wherein the at least one dismantling member is a circular saw, and the method further comprises: operating the circular saw to cut away a segment of the steam generator.

50. The method of claim 48, wherein the at least one dismantling member is a reciprocating saw, and the method further comprises: operating the reciprocating saw to cut away a segment of the steam generator.

51. The method of claim 48, wherein the at least one dismantling member is an oxy acetylene torch, and the method further comprises: operating the oxy acetylene torch to cut away a segment of the steam generator.

52. The method of claim 48, wherein the at least one dismantling member is a shear cutter, and the method further comprises: operating the shear cutter to cut away a segment of the steam generator.

53. The method of claim 48, further comprising: operating each mechanical arm assembly to dismantle the steam generator into a plurality of segments.

54. The method of claim 53, wherein each mechanical arm assembly further comprises at least one decontaminating member, and the method further comprises: operating each decontaminating member to remove contaminants from the steam generator.

55. The method of claim 54, wherein the at least one decontaminating member is a shot blaster, and the method further comprises: operating the shot blaster to remove contaminants from at least one of the plurality of segments.

56. The method of claim 54, wherein the at least one decontaminating member is a decontaminate spray nozzle, and the method further comprises: operating the decontaminate spray nozzle to remove contaminants from at least one of the plurality of segments.

57. The method of claim 54, wherein the at least one decontaminating member is a suction nozzle, and the method further comprises: operating the suction nozzle to remove contaminants from at least one of the plurality of segments.

58. The method of claim 54, wherein the mechanical assembly further comprises a gantry frame within the chamber, and the method further comprises: moving the gantry frame along the longitudinal axis of the steam generator for moving the at least one mechanical arm assembly.

59. The method of claim 58, wherein the gantry frame comprises at least two vertical frame members for mounting each mechanical arm assembly, and the method further comprises: moving each mechanical arm assembly along the longitudinal axis of each vertical frame member.

60. The method of claim 59, wherein each of the at least two vertical frame members has a bottom end movable along the ground and a top end opposite the bottom end, and the method further comprises: moving the bottom end along the ground to change the position of each mechanical arm assembly along the longitudinal axis of the steam generator.

61. The method of claim 60, wherein the mechanical assembly further comprises at least one gantry guide within the chamber for movably mounting the bottom end of at least one of the at least two vertical frame members of the gantry frame, and the method further comprises: directing the movement of the gantry frame using each gantry guide.

62. The method of claim 61, wherein each gantry guide runs adjacent to the steam generator in a direction along the longitudinal axis of the steam generator, and the method further comprises: directing the movement of the gantry frame along the longitudinal axis of the steam generator.

63. The method of claim 62, wherein the gantry frame further comprises at least one horizontal frame member connected to the top end of each of the at least two vertical frame members, and the method further comprises: positioning the horizontal frame member above the steam generator.

64. The method of claim 63, further comprising passing the steam generator through an area defined by the at least two vertical frame members and the at least one horizontal frame member of the gantry frame while moving the gantry frame along the longitudinal axis of the steam generator.

65. The method of claim 64, wherein the gantry frame further comprises at least one elevator system integrated into each vertical frame member, wherein the method further comprises: moving the at least one elevator system along the longitudinal axis of each vertical frame member for moving the at least one mechanical arm assembly.

66. The method of claim 65, wherein each elevator system comprises an elevator platform adjacent to the steam generator for mounting each mechanical arm assembly, and the method further comprises: moving the elevator platform to move each mechanical arm assembly along the longitudinal axis of each vertical frame member.

67. The method of claim 66, wherein the gantry frame further comprises a carrier assembly slidably mounted on the at least one horizontal frame member of the gantry frame, and the method further comprises: positioning the carrier assembly above a segment to be cut from the steam generator.

68. The method of claim 67, wherein the carrier assembly further comprises a segment carrier, and the method further comprises: extending the segment carrier from the carrier assembly to the steam generator for collecting the segment to be cut from the steam generator.

69. The method of claim 68, wherein the segment carrier is a magnetic lift, and the method further comprises: magnetically holding the segment to be cut from the steam generator.

70. The method of claim 68, wherein the segment carrier is an operable grasping member, and the method further comprises: grasping the segment to be cut from the steam generator.

71. The method of claim 68, wherein the mechanical assembly further comprises a secondary workstation within the chamber, and the method further comprises: performing a secondary dismantling process on the plurality of segments.

72. The method of claim 71, wherein the secondary dismantling process comprises shot blasting the plurality of segments for further removing contaminants.

73. The method of claim 71, wherein the secondary dismantling process comprises spraying the plurality of segments with a decontaminating spray for further removing contaminants.

74. The method of claim 71, wherein the secondary dismantling process comprises cutting the plurality of segments into a plurality of smaller segments for improving storability.

75. The method of claim 71, wherein the mechanical assembly further comprises a storage bin within the chamber, and the method further comprises: storing a plurality of finished segments from the plurality of segments in the storage bin.

76. The method of claim 75, further comprising moving the gantry frame from a first position around the steam generator to a second position over the secondary workstation and storage bin.

77. The method of claim 76, further comprising moving a debris control curtain within the chamber for separating the chamber into two compartments.

78. The method of claim 77, further comprising performing the dismantling procedure on the steam generator on a dirty side of the debris control curtain opposite a clean side.

79. The method of claim 78, further comprising operating an air handling unit within the chamber for maintaining a negative air pressure within the dirty side to prevent contaminated air from escaping to the clean side.

80. The method of claim 79, further comprising operating the air handling unit within the chamber for maintaining a negative air pressure within the chamber to prevent contaminated air from escaping to the exterior of the structure.

81. The method of claim 80, further comprising operating a plurality of cameras within the chamber for observing the chamber from outside the structure.

82. The method of claim 81, wherein the plurality of cameras comprises a plurality of cameras mounted around an upper perimeter of the chamber for providing an aerial view of the system, and the method further comprises: operating the plurality of cameras to oversee the dismantling procedures.

83. The method of claim 82, wherein the plurality of cameras further comprises a plurality of cameras mounted on the mechanical assembly, and the method further comprises: operating the plurality of cameras to view from each component of the mechanical assembly.

84. The method of claim 83, wherein the at least one support member comprises an upper support region sized and shaped to engage with an outer metal shell of the steam generator, and the method further comprises: mounting the steam generator on the upper support region of each support member.

85. The method of claim 84, further comprising moving the gantry frame back to the first position around the steam generator from the second position over the secondary workstation and storage bin, wherein the first position is variable along the longitudinal axis of the steam generator dependent on the location of the next segment to be cut.

86. The method of claim 85, further comprising programming the mechanical assembly to sequentially follow the dismantling procedure.

87. The method of claim 85, wherein the method further comprises an operator located at a location external to the structure operating the mechanical assembly via the plurality of cameras to follow the dismantling procedure.
